(19) United States
(12) Patent Application Publication
(10) Pub. No.: US 2014/0130298 A1
(43) Pub. Date: May 15, 2014

(54) Novel Pen or Pencil Sleeve Device

(71) Applicant: Eugene Barry Vassel, Rockville Center, NY (US)

(72) Inventor: Eugene Barry Vassel, Rockville Center, NY (US)

(73) Assignee: Gene Vassel, Rockville Center N.Y., Rockville Center, NY (US)

(21) Appl. No.: 13/677,245

(22) Filed: Nov. 14, 2012

(51) Int. Cl. B43K 23/00

(52) U.S. Cl. CPC B43K 23/00
USPC 15/443

(57) ABSTRACT

A polymer based sleeve made of one or several elements is used to sheath a pen or pencil and is receptive to inks in order to allow individualized artwork to be placed over the pen or pencil. In addition, the sleeve material can be made of an open, or closed cell elastomer foam for comfortable handling, and increased grip. The invention is tubular in it's inner diameter and can present a varied geometry in the cross section.

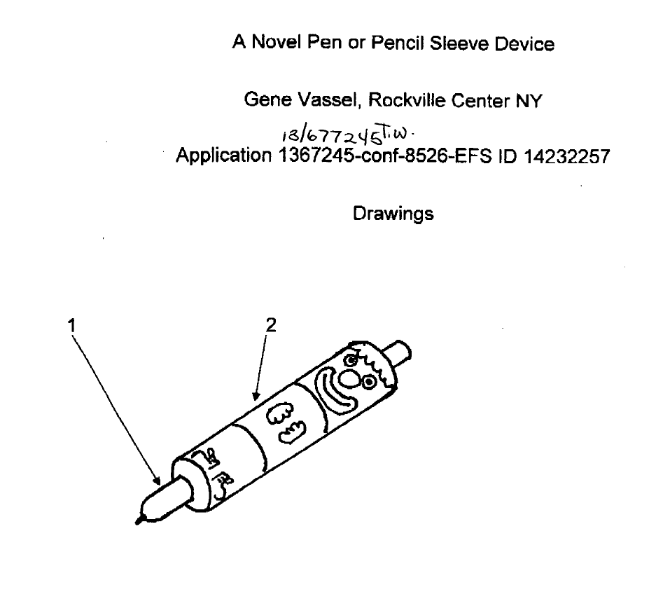

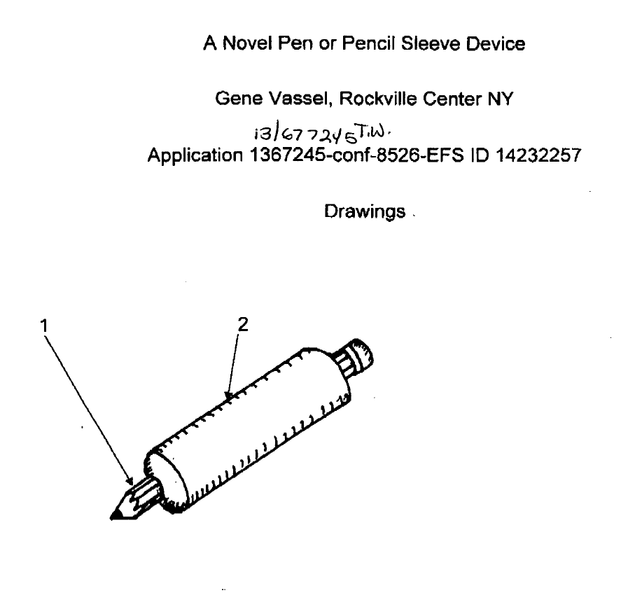

### FIELD OF THE INVENTION

The field of the invention is pen and pencil accessories.

### BACKGROUND OF THE INVENTION

The prior art for the invention includes items in the public domain as well as patent issued claims currently assigned to owners. In 1906, U.S. Pat. No. 836,905, whose inventor was John Whitehouse of NY, N.Y. and the assignee Le White Manufacturing Company of NY, N.Y. describes a protective sheath of celluloid polymer being used for improved pen life. In 1941 Charles Lorber of Louisville, Ky. issued U.S. Pat. No. 2,236,194 describes rubber sieves being used for comfort and grip. U.S. Pat. No. 4,526,547 by inventor Chris Rusk of Crawfordsville, Ind., describes an instructional device for holding writing instruments correctly using a device through which the instrument is inserted. The invention then directs the fingers onto correct positions. Pat. Des. 396059 by Plantz et al. describes an oval sleeve with three equidistant flat oval surfaces running against the longitudinal axis with the writing device. In U.S. Pat. No. 6,296,409 B1 Cherry et al. Describe a pre-printed grip sleeve over a writing instrument.

### OBJECTS OF THE INVENTION

One object of the invention is to develop an accessory for ink pens. Yet another object of the invention is to develop an accessory for use with pencils. Yet another object of the invention is to develop an accessory for felt tip pens and markers. An additional object of the invention is to provide an outer pen or pencil surface which can receive custom artwork and preserve it during use. Yet another object of the invention is to develop greater comfort and grip for writing device users.

### SUMMARY OF THE INVENTION

Foamed polymer tube segments or tube are drawn or written upon by the user or owner, either before, or after the tube it fitted over a pen, pencil or marker. The surface is sealed post artwork with wax or a coating.

### DETAILED DESCRIPTION OF THE INVENTION

An open-cell foam or a closed cell foam material with acceptable surface permeability to inks is drawn over a writing device and used for enhanced comfort and grip. The device is artistically decorated by the owner, user, or on a custom basis by an artist.

### EXAMPLES OF THE INVENTION

### Explanation of Drawings

Drawing 1 of 2 shows a three segment pen polymer foam device which acts as a toy puzzle. Each of the three segments holds part of the clown toy and has to be assembled correctly by the child.

Drawing 2 of 2 shows a one segment polymer foam core on a lead pencil which can hold a signature or a drawing on the surface.

In both drawings the arrow number 1 shows the writing device, and arrow number 2 shows the placement of the invention on the writing device.

1. A tubular polymer foam sleeve which receives inks for personalized art work and can be added over a pen or pencil in segments.

2. A tubular polymer elastomer sleeve which receives inks for personalized art work and can be added over a pen or pencil in segments.

3. The claim in 1 where the outer surface is consistently curved.

4. The claim in 2 where the outer surface contains flat surfaces.

5. The claim in 1-4 where the sleeve is a polyolefin polymer.

6. The claim in 1-4 where the sleeve is a silicone.

7. The claim in 1-6 where the surface is coated with a coating for ink adhesion.

8. The claim in 1 where the foam is open cell.

9. The claim in 1 where the foam is closed cell.

10. The claim in 4 where the cross section is a polygon.

11. The claims in 1-10 where the surface has been flame etched for increased surface energy.

12. The claims in 1-10 where the surface is plasma etched.

13. The claims in 1-10 where the surface is chemically etched.

14. The claims in 8-9 where the foam polymer is ethylene vinyl acetate.

15. The claims in 8-9 where the foam polymer is chloroprene.

16. The claims in 8-9 where the foam polymer is latex.

17. The claims in 8-9 where the foam polymer is [symbol]
